(19) United States
(12) Patent Application Publication
(10) Pub. No.: US 2006/0101504 A1
(43) Pub. Date: May 11, 2006

(54) Method and system for performing searches for television content and channels using a non-intrusive television interface and with reduced text input

(75) Inventors: Murali Aravamudan, Windham, NH (US); Rakesh D. Barve, Bangalore (IN); Ajit Rajasekharan, West Windsor, NJ (US)

Correspondence Address: WILMER CUTLER PICKERING HALE AND DORR LLP, 60 STATE STREET, BOSTON, MA, 02109, US

(73) Assignee: Veveo.tv, Inc., Andover, MA (US)

(21) Appl. No.: 11/204,546

(22) Filed: Aug. 15, 2005

Related U.S. Application Data
(60) Provisional application No. 60/626,274, filed on Nov. 9, 2004.
(60) Provisional application No. 60/676,768, filed on May 2, 2005.

(51) Int. Cl. H04N 7/16; G06F 13/00; H04N 5/445; G06F 3/00

(52) U.S. Cl. 725/136; 725/135; 725/42

(57) ABSTRACT

A method and system are provided for identifying a television content item or a television channel desired by a television viewer from a set of television content items and television channels. A non-intrusive interface is provided to the viewer on a television display. The television viewer using the non-intrusive interface inputs a reduced text search entry directed at identifying a desired television content item or a television channel. The reduced text search entry includes one or more characters of a descriptor relating to the desired television content item or the television channel. The system dynamically identifies a group of television content items or television channels from the set of television content items and television channels matching the search entry as the television viewer enters each character of the reduced text search entry. The television content items or television channels of the group are ordered in accordance with one or more given criteria. The system displays on the non-intrusive interface identification of one or more of the television content items or television channels of the identified group as ordered.

### RELATED APPLICATIONS

The present invention is based on and claims priority from the following U.S. provisional patent applications assigned to the assignee of the present application, each of which is incorporated by reference herein in its entirety: (1) U.S. Patent Application Ser. No. 60/676,768 filed May 2, 2005 and entitled “A Non-Intrusive Television Interface To Search With Reduced Text Entry For Instant Content Availability And Rendering Desired Content,” and (2) U.S. Patent Application Ser. No. 60/626,274 filed Nov. 9, 2004 and entitled “Television Systems and Associated Methods.”

### BACKGROUND OF THE INVENTION

1. Field of Invention

The present invention generally relates to a method and system for performing searches for television content and channels, and more particularly, to a method and system for performing searches for television content and channels using a non-intrusive television interface and reduced text input.

2. Description of Related Art

User interfaces for finding television content in early television systems were relatively simple. Television viewers could tune to a channel to locate desired content by entering a channel number or clicking channel navigation (up/down) buttons on the television or on a remote control device. User interfaces have evolved over time to more complex and elaborate interfaces such as interactive EPGs (Electronic Program Guides) now commonly used for browsing and searching for television content.

There has been significant recent proliferation in content choices for television viewers. The increase in content choices has resulted largely from channel proliferation, content disaggregation, and an increase in content source options. With this proliferation of content choices, conventional user interfaces, particularly EPGs, have proven inadequate in helping users quickly and easily find channels and content of interest.

The number of television channels available to television viewers, e.g., subscribers of satellite and cable networks, has proliferated, in many cases beyond double digits and approaching triple digits. This has made it particularly difficult for users to remember the channels by their numbers. Users are more likely to forget the number assigned to a channel than the symbolic name assigned to the channel (e.g., CNN, NBC, PBS etc.). Moreover, when a user is mobile, i.e., not at his or her usual home, and desires to view a given channel, e.g., CNN, his or her memory of the channel number may not be useful since CNN would typically be assigned a different channel number by different operators. Additionally, the growth in the number of channels has also made use of conventional two dimensional grid-based EPG interfaces tedious in finding particular programs of interest and channels.

Early VCRs (video cassette recorders) enabled users to time-shift programs so that the programs could be watched whenever desired. The advent of PVRs (Personal Video Recorders) has, however, immensely catalyzed this disaggregation of programs, further diminishing the value of the channel paradigm. A direct consequence of this phenomenon is the proliferation of available content that can be viewed at any given time.

Additionally, there has been a significant increase in content source options for viewers. As the bandwidth for data transmission to homes has increased, new sources of content such as VOD (video-on-demand) and IPTV (Internet Protocol TV) have become available. This has further increased the available content accessible to viewers.

A need exists for a television search interface that can help users find desired channels or content quickly and easily.

### BRIEF SUMMARY OF EMBODIMENTS OF THE INVENTION

In accordance with one or more embodiments of the invention, a method and system are provided for identifying a television content item or a television channel desired by a television viewer from a set of television content items and television channels. A non-intrusive interface is provided to the viewer on a television display. The television viewer using the non-intrusive interface inputs a reduced text search entry directed at identifying a desired television content item or a television channel. The reduced text search entry includes one or more characters of a descriptor relating to the desired television content item or the television channel. The system dynamically identifies a group of television content items or television channels from the set of television content items and television channels matching the search entry as the television viewer enters each character of the reduced text search entry. The television content items or television channels of the group are ordered in accordance with one or more given criteria. The system displays on the non-intrusive interface identification of one or more of the television content items or television channels of the identified group as ordered.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

For a more complete understanding of various embodiments of the present invention, reference is now made to the following descriptions taken in connection with the accompanying drawings in which:

FIG. 1 illustrates a television content and channel search system in accordance with one or more embodiments of the invention.

FIG. 2 illustrates various possible device configuration options for a device for performing searching in accordance with one or more embodiments of the invention.

FIG. 3 illustrates an example of a non-intrusive interface for content and channel searching in accordance with one or more embodiments of the invention with an exemplary user text input.

FIG. 4 illustrates the FIG. 3 non-intrusive interface with a different exemplary user text input.

FIG. 5 illustrates a screen shot of another example non-intrusive interface in accordance with one or more embodiments of the invention.

FIG. 6 is a flow chart illustrating the process of user performing a search in accordance with one or more embodiments of the invention.

FIG. 7 illustrates the various states a user can traverse to get to a desired result in accordance with one or more embodiments of the invention.

FIG. 8 is a flow chart illustrating the process of a user selecting context specific actions performed on a selected content link in accordance with one or more embodiments of the invention.

Like reference numerals generally refer to like elements in the drawings.

### DETAILED DESCRIPTION OF THE PREFERRED EMBODIMENTS

Briefly, as will be described in further detail below, methods and systems are provided in accordance with various embodiments of the invention for assisting television viewers in identifying desired television channels and television content items. Television content items can include a wide variety of video/audio content including, but not limited to, television shows, movies, music videos, or any other identifiable content that can be selected by a television viewer. Searching for television content items can be performed across disparate content sources including, but not limited to, broadcast television, VOD, IPTV, and PVR (local and network).

The television viewer is provided with a non-intrusive interface on a television display. The non-intrusive interface preferably only occupies a small space on the display. The non-intrusive interface is preferably overlaid on the content item being currently viewed, thereby enabling user to watch an existing program on television while initiating a search for another. The viewer can, using the non-intrusive interface, input a reduced text search entry directed at identifying a desired television content item or a television channel. The reduced text search entry comprises one or more characters of a descriptor relating to the desired television content item or television channel. The search system dynamically identifies a group of one or more television content items or television channels matching the search entry as the television viewer enters each character of the reduced text search entry. The search results are displayed to the viewer on the non-intrusive interface. The results are preferably ordered based on given criteria such as temporal relevance, popularity and personal preferences. The user can navigate through the search results, and after the user has found and selected a desired content item or channel, the system can automatically retrieve and render the selected content or tune to the selected channel. If content desired by the viewer is not available for instant viewing, the interface can identify and offer related alternatives to the desired content that are available for viewing. Additionally, when instant viewing is not possible, the interface can offer content specific alternatives for deferred viewing. The interface can also offer visual cues to inform the viewer of the availability of content for instant and deferred viewing.

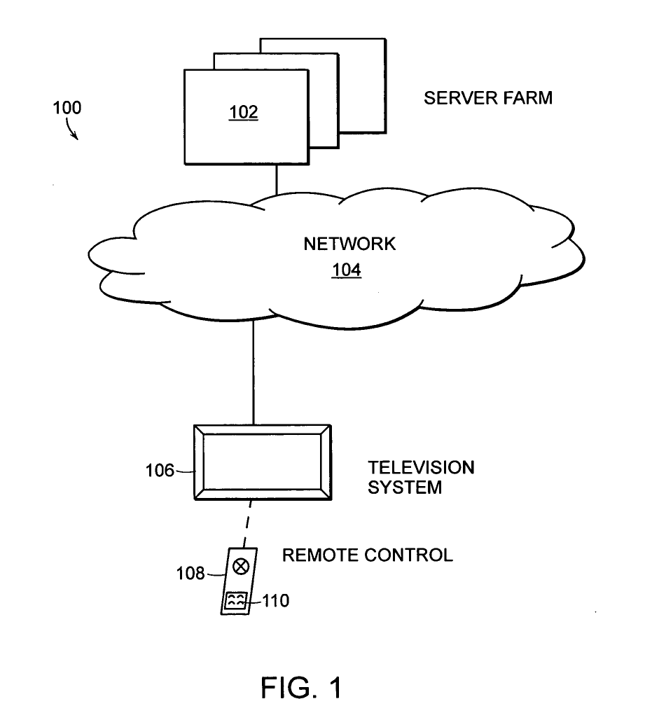

FIG. 1 schematically illustrates an overall system 100 that can be used for performing a search for television channels and content in accordance with one or more embodiments of the invention. The system includes a server farm 102, a network 104, and a plurality of television systems 106 operated by television viewers (i.e., television users). In accordance with one or more embodiments of the invention, the server farm 102 processes search queries and is the source of search data and relevance updates. The server farm 102 can also be the source of or be linked to a source of at least some of the available television content (e.g., a cable or satellite television operator). The network 104 functions as the distribution framework for transmitting data from the server farm 102 to the televisions. The distribution network 104 could be wired or wireless connections or some combination thereof. Examples of possible networks can include cable television networks, satellite television networks and I.P.-based television networks. Users can view content on television systems 106 connected to the distribution network 104.

Each television system includes a search system that allows users to find desired television content or channels. The search system includes a text input interface, which is preferably a remote control device 108 having keypad 110 or keyboard through which the user can enter text. The text input interface can also be a keypad on the television unit or a set-top box or other device connected to the television. The text input interface will typically include a keypad having a limited set of keys that are overloaded with multiple characters and numbers. By way of example, one button could be associated with the number “2” and the letters “A”, “B”, and “C”. Text entry optimizing technology could be provided using a variety of known of technologies including, but not limited to, vocabulary, predictive, and statistical schemes such as T9, eZiText, iTap and LetterWise. Such text entry optimizing technology allows users to more quickly and easily input desired text on keypads with overloaded keys.

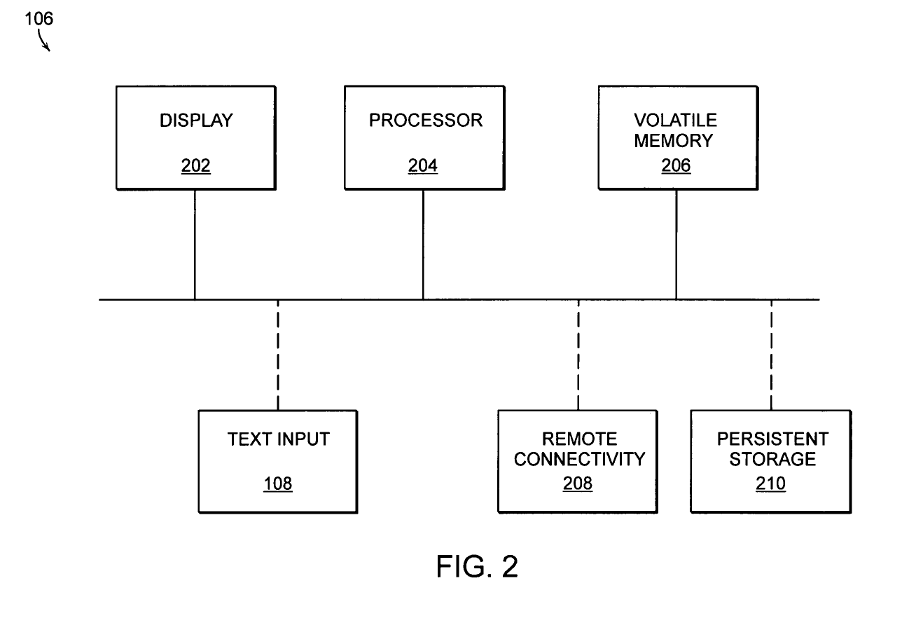

FIG. 2 illustrates exemplary device configurations for performing searching in accordance with one or more embodiments of the invention. In one configuration, the television system 106 has display 202, a processor 204, volatile memory 206, text input interface 108, remote connectivity 208 to the server farm 102 through the network 104, and a persistent storage 210.

In another possible device configuration, the television system 106 might not have local persistent storage 210. In such a configuration, the device 106 can use remote connectivity 208 to submit the query to a server farm 102 and retrieve results from it.

In another exemplary configuration, the television system 106 may not have remote connectivity 208. In this configuration, the search database may be locally resident on a local persistent storage 210. The persistent storage 210 may be a removable storage element such as SD, SmartMedia, CompactFlash card etc.

In a configuration of the television system with remote connectivity 208 and persistent storage 210 for searching, the device may use the remote connectivity for search relevance data update or for the case where the search database is distributed on the local storage 210 and on the server 102.

In one or more embodiments of the invention, a television system 106 may have a set-top box with a one-way link to a satellite. In this configuration, all search data including relevance updates may be downloaded to the device through the satellite link to perform local search. Relevance updates could be periodically done through this one way link.

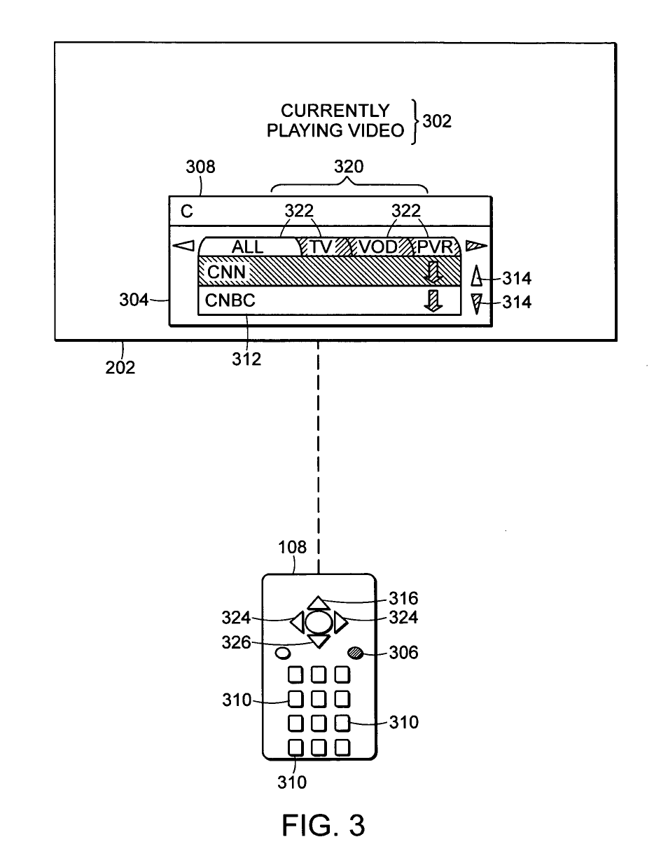

FIG. 3 illustrates a non-intrusive search interface in accordance with one or more embodiments of the invention. A television system 106 includes a display screen 202 having a program or some content 302 currently playing on the screen. The user can initiate or launch a non-intrusive search interface 304 on the display screen 202. In a preferred embodiment of the invention, a remote control device 108 used to operate the television includes a shortcut key 306 to initiate the non-intrusive interface 304. The non-intrusive interface 304 is overlaid on top of the television content 302 playing on the screen. It occupies only some (preferably only a small area) of the area of the screen, so that a viewer can still see the program playing on the screen. The interface is considered “non-intrusive” in that the viewer can continue to at least partially view content currently playing on the television display while conducting a search for other content or channels.

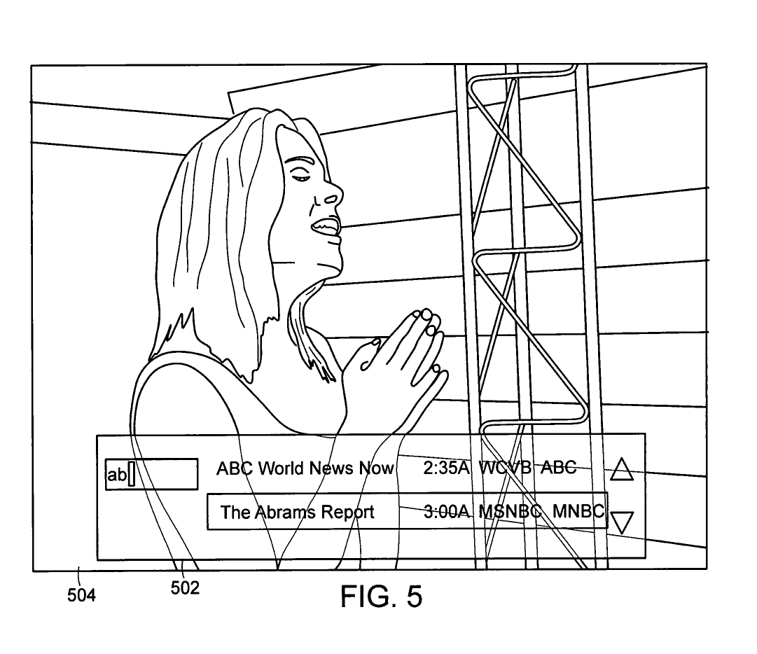

In addition, the interface 304 is preferably at least partially translucent or semi-transparent, allowing the television content playing on the screen over which the interface is overlaid to be at least partially visible through the interface. Translucent or semi-transparent images can be achieved by alpha-blending or similar techniques. Another example of a non-intrusive interface 502 is shown in FIG. 5, which is a screenshot of a television display 504 having the non-intrusive translucent interface 502 overlaid on a program playing on the television. Various other alternative non-intrusive interfaces are also possible that allow users to initiate searches while being able to continue observing at least a portion of the content being displayed on the screen including e.g., interfaces overlaid on the program being played, in which the characters displayed in the interface are opaque or otherwise easily visible. Other examples of non-intrusive interfaces include interfaces that are displayed on one portion of the screen while content is being displayed on another portion of the screen.

The non-intrusive interface 304 shown in FIG. 3 includes a text entry field 308, in which users can enter text for a search using the text entry buttons 310 of the remote control device 108. The non-intrusive interface 304 also includes a results window 312, in which the results of a search are displayed. As shown in the FIG. 3 example, when the user has entered one character “C” in the text entry field 308, the results of the search include the TV channels, “CNN” and “CNBC” which are displayed in the results window 312. Only a given number of the results (in the FIG. 3 example, two) are displayed at a time. The user can scroll down using the vertical navigation interface 314 using the vertical navigation buttons 316 on the remote control 108 to see additional results that were not initially displayed in the results window.

The results of the search are preferably ordered in the results window 312 to reflect what is expected to be of greater interest to the viewer. Different criteria can be used to determine the ordering. In accordance with one or more embodiments of the invention, the ordering of results is one of or a combination of two or more of: temporal relevance, popularity and personal preferences that may have been determined implicitly or explicitly. Temporal relevance can be used to favor programs whose timing may be more of interest to the viewer. For example, if the user entered NBA, then the system would list the games in order of temporal relevance such as those in progress or are scheduled to begin in the near future are listed at the higher on the list. The popularity criterion can be used to favor programs or channels that are more popular than others. The personal preference criterion can be used to favor programs or channels that the user has indicated preference for in prior user selections. For example, if a user frequently scrolls down to “CNBC” and selects it, the system would over time place CNBC higher in the list of results over a more generally popular channel such as CNN. Furthermore, identity independent time-based usage pattern learning algorithms can be applied in conjunction with personalization to apply the results ordering rules in an appropriate context.

The FIG. 3 non-intrusive interface optionally includes a search space filter interface 320 to filter results in accordance with particular sources of or particular types of content (e.g., television, VOD, PVR, and IPTV). The interface includes a set of tabs 322 associated with the sources or types of content. A user can, if desired, select one of the tabs 322 to limit the search results to a particular source or type of content of interest. The semantics of navigating the horizontal tabs using the horizontal navigation buttons 324 on the remote control device 108 is content specific and is also determined by the search string.

In accordance with one or more embodiments of the invention, further information related to a selected program or channel can be displayed on the non-intrusive interface 304 if desired. For example, if the TV tab is selected, then navigating horizontally after selecting one of one of the channels in the results window, could display the immediately following program. If the user had searched for a cast member (e.g., Tom Cruise), horizontal navigation could be used by the viewer to, e.g., navigate through all available programs that contain that cast member.

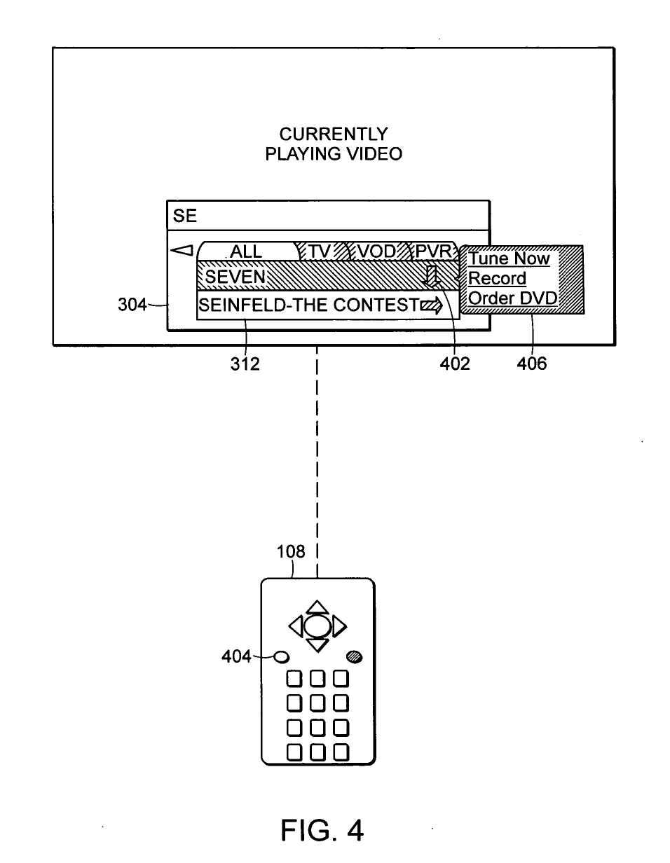

In the example illustrated in FIG. 4, after the user enters the string “SE”, two results are dynamically displayed in the visible results window: the first one being the movie “SEVEN” which could be a VOD source, and the second one the TV serial “SEINFELD”. In accordance with one or more embodiments of the invention, visual cues can be provided adjacent to the results indicate the availability of the content. In this example, for the case of Seinfeld, an icon 402 (in this particular example a shaded downwardly pointed arrow) is provided to indicate that the program will be on shortly. The user can then be given the choice to either directly initiate a recording of the program by clicking a “record” button 404 (commonly available on remote control devices) after scrolling to that result or by selecting the record action from an “actions menu” 406 obtained by selecting the result as shown in FIG. 4. The “actions menu” 406 can also provide an option to the user to set a reminder to notify the user when the show will be on. Additionally, the user could horizontally navigate to see if there is an equivalent or similar category program available now from any of the content sources.

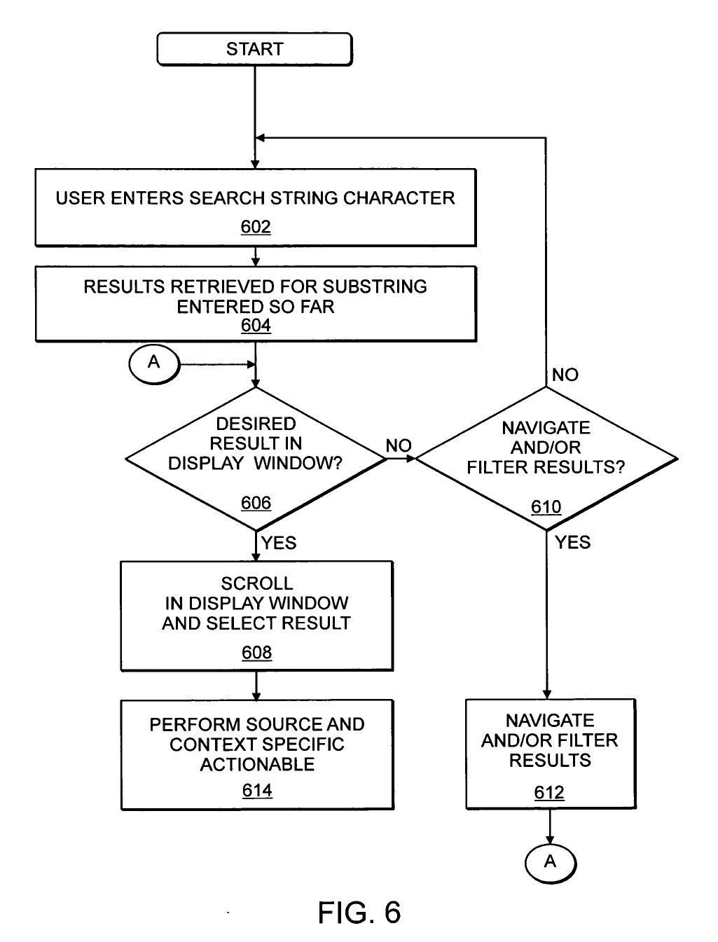

FIG. 6 illustrates a process of searching for television content in accordance with one or more embodiments of the invention. A user initially enters a search string character at 602, which is a reduced text input representation of the content or channel desired by the user. The reduced text input could be, e.g., a variable size prefix or an acronym or other abbreviation of the intended query (e.g., C to represent CNN, or BP, B P, BR P, B PI to represent Brad Pitt etc.). Results are preferably dynamically retrieved for the cumulative substring of characters entered up to that point and displayed in the display window of the user interface at 604. U.S. Patent Application Ser. No. 60/664,879 entitled “Method And System For Performing Searches For Television Content Using Reduced Text Input” filed on May 24, 2005, which is assigned to the assignee of the present application, is incorporated herein by reference in its entirety. That application describes a particular technique of dynamically retrieving results as each character of a reduced text substring of characters is entered by the user.

As indicated above, the ordering of results in the display window is preferably based on a relevance function that can, e.g., be a domain specific combination of temporal relevance and popularity. If the result desired by the user is displayed in the results window at 606, the user can scroll to the desired result within the displayed window and select the desired result at 608. If the desired result is the first entry in the display window, it preferably is selected by default, thus obviating the need to scroll through the display window.

If the desired result is not in the display window at step 606, the user can at step 610 decide whether to filter the results using the content source tabs 322 to narrow the results and/or whether to scroll through pages of results not initially displayed in the display window. If so, the user can perform filtering and/or scrolling at step 612. Then, the user can return to step 606 to determine whether the desired result is in the display window.

If the user chooses not to filter the results or to scroll through pages of results at 610, he or she can continue to add new characters to the search string at step 602 to obtain further search results.

The dynamic updating of results for each character entered enables the user to quickly get to the results, in contrast to discovering there are no results match after typing the entire text. Once the user finds the desired result, it can be selected at 614 to initiate the action that is appropriate to the selection. For example, one action may be to change the channel to the selected channel, and another action might be to record the program for later viewing.

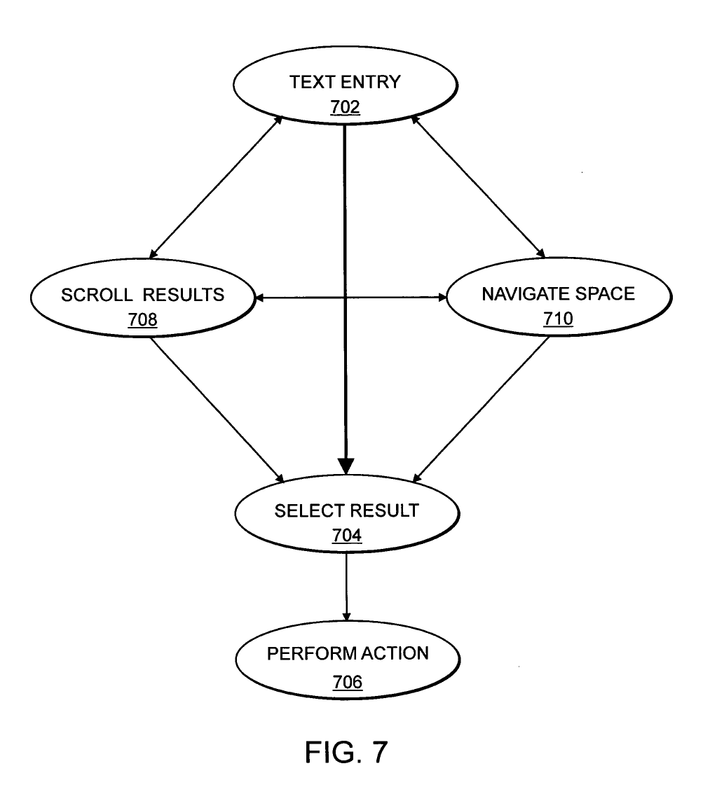

FIG. 7 illustrates possible state transitions to arrive at a result by reduced text entry. The generally minimal path for arriving at a desired result occurs when a user enters one or a few characters identifying the desired program or channel at 702, and gets the result in the visible display window, with the desired result already highlighted. The user would only have to select the result at 704 to tune to the desired content 706. This path is similar to the original simple interface of channel selection (in which a user entered a channel number to switch to that channel) with the addition of a select action. In accordance with various embodiments of the invention, a user can choose content from a much larger space comparable to the simplicity and ease of use of the original interface.

When the result is not the first selection or is not visible in the results window, the user can scroll through the results at 708 or alternatively apply a filter at 710 to cull the results space. In accordance with one or more embodiments of the invention, the interface displays the number of results for a given search entry. This can give the user a visual cue to use the filter when the results space is large. A filter may be chosen by default as a consequence of personalization.

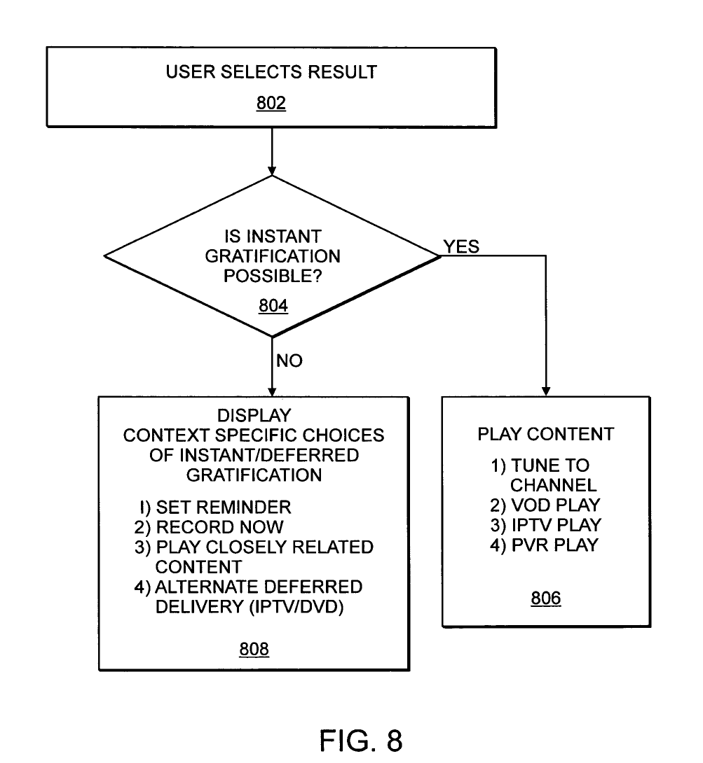

FIG. 8 illustrates the steps involved in performing an action responsive to a selection of a search result made by the user. Once the user has selected a result in the results window at 802, the user determines at 804 whether the selected content is currently available for viewing. If so, a set of context specific choices are displayed to the viewer at 806 to play the content. In the case of a channel selection or a television program that is being currently broadcast, the action may be tuning to the channel directly. Alternatively, a VOD, IPTV, or PVR content fetch can be initiated for content that is instantly available and the fetched content is rendered. When the content is not available, the system can at 808 provide alternate choices for closely related content that is instantly available. If the content is available on TV in the near future, the user is provided an option to initiate recording of the content. (Additionally, the user may wish to record the content even if it is currently available. This would allow the viewer to record that content and, e.g., view some alternative program now.) When the content is neither currently available or available in the near future, the user can also be given the option to procure the content in alternate forms, such as, e.g., on a DVD (if available on DVD). In this regard, the system may automatically place an order for the DVD with a merchant such as, e.g., Amazon.com, or a DVD rental company such as, e.g., Netflix.com. It should be noted that the various content specific choices for near and deferred gratification are not mutually exclusive. For example, user may choose to both record a program and order DVD for that program.

If the user is not able to find desired content, he or she can be given a choice to transition to a full screen search to perform a more elaborate search for content.

Methods of identifying content from a user input in accordance with various embodiments of the invention are preferably implemented in software, and accordingly one of the preferred implementations is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

1. A method of identifying a television content item or a television channel desired by a television viewer from a set of television content items and television channels, said method comprising:
(a) providing a non-intrusive interface on a television display;
(b) receiving from the television viewer who is using the non-intrusive interface a reduced text search entry directed at identifying a desired television content item or a television channel, said reduced text search entry comprising one or more characters of a descriptor relating to said desired television content item or said television channel;
(c) dynamically identifying a group of content items or television channels from said set of television content items and television channels matching said search entry as said television viewer enters each character of said reduced text search entry;
(d) ordering the television content items or television channels of said group in accordance with one or more given criteria; and
(e) displaying on said non-intrusive interface identification of one or more of said television content items or television channels of said group identified in step (c) as ordered in step (d).

2. The method of claim 1 further comprising receiving from the viewer a selection of one of said one or more television content items or television channels displayed in step (e), and a desired action with respect to said selection.

3. The method of claim 2 further comprising performing said action, wherein said action comprises tuning to a television channel or retrieving the selected content item from a content source.

4. The method of claim 3 wherein said content source comprises a video-on-demand system, an IPTV system, or a personal video recorder.

5. The method of claim 2 further comprising performing said action, wherein said action comprises recording a selected content item, reminding the viewer when a selected content item is broadcasted, finding a related content item, or retrieving the selected content item from a content source.

6. The method of claim 1 further comprising receiving from the viewer a selection of one of said one or more television content items or television channels displayed in step (d), and automatically fetching and rendering the selected content item or tuning to the selected television channel.

7. The method of claim 1 further comprising identifying and offering to the viewer an alternative content item when the viewer is unable to find a desired content item.

8. The method of claim 1 further comprising displaying on said non-intrusive interface visual cues to inform the viewer of the availability of content for instant and deferred viewing.

9. The method of claim 1 wherein said non-intrusive interface is overlaid on content currently playing on said television display.

10. The method of claim 9 wherein said non-intrusive interface includes at least portions thereof that are translucent thereby allowing said content currently playing on said television display to be at least partially visible to the viewer through the non-intrusive interface.

11. The method of claim 1 wherein said non-intrusive interface includes a field for entry of said reduced text search entry and a window for displaying a given number of said television content items or television channels of said group identified in step (c).

12. The method of claim 1 further comprising filtering said television content items identified in step (c) in accordance with the source or category of said television content items and displaying selected television content items in said non-intrusive interface.

13. The method of claim 1 further comprising providing to the viewer through said non-intrusive interface information related to said selected television content item or television channel.

14. The method of claim 1 wherein said television content items or television channels are ordered based on temporal relevance, popularity, or personal preferences of the viewer.

15. The method of claim 1 wherein said method is implemented in a device included in or proximate to a television set.

16. The method of claim 1 wherein step (c) is performed by a server system remote from said viewer in communication with a device included in or proximate to a television set.

17. The method of claim 1 further comprising enabling the viewer to scroll through additional content items or television channels of said group identified in step (c) by displaying identification of said additional content items or television channels when directed by said viewer.

18. The method of claim 1 wherein said user enters said reduced text search entry on a remote control device having keys overloaded with two or more characters.

19. A system for identifying a television content item or a television channel desired by a television viewer from a set of television content items and television channels, said system comprising:
a device for providing a non-intrusive interface on a television display, and for receiving from the television viewer who is using the non-intrusive interface a reduced text search entry directed at identifying a desired television content item or a television channel, said reduced text search entry comprising one or more characters of a descriptor relating to said desired television content item or said television channel; and
an apparatus in communication with said device for dynamically identifying a group of content items or television channels from said set of television content items and television channels matching said search entry as said television viewer enters each character of said reduced text search entry;
wherein said device or said apparatus orders the television content items or television channels of said group in accordance with one or more given criteria; and
wherein said device displays on said non-intrusive interface identification of one or more of said television content items or television channels of said group as ordered.

20. The system of claim 19 wherein the device receives from the viewer a selection of one of said one or more television content items or television channels displayed in the interface, and a desired action with respect to said selection.

21. The system of claim 20 wherein said device performs said action, wherein said action comprises tuning to a television channel or retrieving the selected content item from a content source.

22. The system of claim 21 wherein said content source comprises a video-on-demand system, an IPTV system, or a personal video recorder.

23. The system of claim 20 wherein said device performs said action, wherein said action comprises recording a selected content item, reminding the viewer when a selected content item is broadcasted, finding a related content item, or retrieving the selected content item from a content source.

24. The system of claim 19 wherein the device receives from the viewer a selection of one of said one or more television content items or television channels displayed in step (d), and automatically fetching and rendering the selected content item or tuning to the selected television channel.

25. The system of claim 19 wherein the apparatus or the device identifies and offers to the viewer an alternative content item when the viewer is unable to find a desired content item.

26. The system of claim 19 wherein the device displays on said non-intrusive interface visual cues to inform the viewer of the availability of content for instant and deferred viewing.

27. The system of claim 19 wherein said non-intrusive interface is overlaid on content currently playing on said television display.

28. The system of claim 27 wherein said non-intrusive interface includes at least portions thereof that are translucent thereby allowing said content currently playing on said television display to be at least partially visible to the viewer through the non-intrusive interface.

29. The system of claim 19 wherein said non-intrusive interface includes a field for entry of said reduced text search entry and a window for displaying a given number of said television content items or television channels of the identified group.

30. The system of claim 19 wherein the device or apparatus filters said television content items of said group in accordance with the source or category of said television content items and displays selected television content items in said non-intrusive interface.

31. The system of claim 19 wherein the device further provides to the viewer through said non-intrusive interface information related to said selected television content item or television channel.

32. The system of claim 19 wherein said television content items or television channels are ordered based on temporal relevance, popularity, or personal preferences of the viewer.

33. The system of claim 19 wherein said device is included in or proximate to a television set.

34. The system of claim 19 wherein said apparatus is a server system remote from said viewer in communication with said device over a network.

35. The system of claim 19 wherein the device enables the viewer to scroll through additional content items or television channels of said group by displaying identification of said additional content items or television channels when directed by said viewer.

36. The system of claim 19 wherein said user enters said reduced text search entry on a remote control device having keys overloaded with two or more characters.

37. A television content and channel search system, comprising:
a server system;
a network; and
a plurality of television systems in communication with said server system through said network, each television system operable by a television viewer for selecting and viewing a desired television channel or a content item from a set of television channels and content items, each television system including a non-intrusive interface on a television display, and a text input device for receiving from the television viewer who is using the non-intrusive interface a reduced text search entry directed at identifying a desired television content item or a television channel, said reduced text search entry comprising one or more characters of a descriptor relating to said desired television content item or said television channel, said television system transmitting said reduced text search entry to said server as said television viewer enters each character of said reduced text search entry; and
wherein for each reduced text search entry received by said server from a television system, said server dynamically identifies a group of content items or television channels from said set of television content items and television channels matching said search entry, and transmits identification of said group of content items or channels to said television system; and wherein said television system displays on said non-intrusive interface identification of one or more of said television content items or television channels of said group in an order determined by one or more given criteria.

38. The method of claim 15 further comprising receiving search data at said device from a communications link.

39. The method of claim 38 wherein said communications link comprises a one-way link for downloading data to said device.

40. The method of claim 38 wherein said communications link comprises a one-way satellite link for downloading data to said device.

41. The method of claim 38 wherein said search data is received at said device periodically.

42. The method of claim 38 wherein said search data includes data on television content items and television channels.

43. The method of claim 38 wherein said search data includes relevance updates.

44. The system of claim 19 wherein said system is included in or proximate to television set operated by the user.

45. The system of claim 44 wherein said system receives search data from a communications link.

46. The system of claim 45 wherein said communications link comprises a one-way link for downloading data to said system.

47. The system of claim 45 wherein said communications link comprises a one-way satellite link for downloading data to said system.

48. The system of claim 45 wherein said system receives said search data periodically.

49. The system of claim 45 wherein said search data includes data on television content items and television channels.

50. The system of claim 45 wherein said search data includes relevance updates.
